(19) United States
(12) Patent Application Publication
(10) Pub. No.: US 2015/0088846 A1
(43) Pub. Date: Mar. 26, 2015

(54) SUGGESTING KEYWORDS FOR SEARCH ENGINE OPTIMIZATION

(71) Applicant: Go Daddy Operating Company, LLC, Scottsdale, AZ (US)

(72) Inventors: Paul Roe, Gilbert, AZ (US); Arnold Blinn, Hunts Point, WA (US)

(73) Assignee: Go Daddy Operating Company, LLC, Scottsdale, AZ (US)

(21) Appl. No.: 14/037,029

(22) Filed: Sep. 25, 2013

(51) Int. Cl. G06F 17/30

(52) U.S. Cl. CPC G06F 17/30864; G06F 17/3089
USPC 707/706

(57) ABSTRACT

The present invention improves the SEO of a website by incorporating related keywords into the website based on an identified category for the website. The category for the website may be identified via keywords within the website matched to one or more categories containing the identified keywords and stored within a database. The keywords may be further matched to one or more related keywords within the one or more categories. Each of these related keywords may be scored according to category relevance, and may further be recommended to the website owner for inclusion on the website. Positive responses by the website owner to the recommended related keywords may increase the related keyword score, while negative responses may decrease the score.

### FIELD OF THE INVENTION

The present invention generally relates to the Internet and, more particularly, to methods for suggesting keywords to improve a website's Search Engine Optimization (SEO).

### SUMMARY OF THE INVENTION

In one embodiment of the invention, universal keywords and related keywords are stored in an electronic database. Each universal keyword is preferably a noun, verb or phrase that appears in some, but not all, websites. Each universal keyword is preferably associated with one or more related keywords. Related keywords may be synonyms of their associated universal keyword or words or phrases people would search for in a search engine when trying to locate a website of the type that would include the universal keyword. A website builder, e.g., a webmaster, website designer or website programmer, may build or design a website having text, i.e. one or more sections containing a string of words. The text may be analyzed, such as by parsing, string matching and/or spidering the website, to find one or more universal keywords. Links, number of images and/or images may also be analyzed to determine universal keywords. All of the related keywords associated with the found universal keywords may be determined, but those related keywords already incorporated into the website are preferably excluded. One or more of the related keywords that have not been excluded may be displayed on an electronic device, such as a desktop computer, laptop, tablet, cell phone, or other mobile device, to the website builder (or person designated by the website builder). The website builder may provide feedback, such as a positive response, negative response or no response, for none, some, each, or all of the related keywords. A positive response indicates that the displayed related keyword is related to the type of website built by the website builder. Each related keyword that receives a positive response from the website builder may then be incorporated into the website to thereby increase the SEO of the website.

In another embodiment of the invention, categories, universal keywords and related keywords are stored in an electronic database. Each category may describe a type or nature of a website, such as a car dealership, legal services, a real estate office, or a restaurant and be associated with one or more universal keywords. Each category is preferably unique. As in the previous embodiment, each universal keyword is preferably associated with one or more related keywords. It should be noted in the embodiments that include categories that the same word may be a universal keyword for two or more categories and have different related keywords depending on the category associated with the universal keyword. It should also be noted in the embodiments that include categories that the same word may be a related keyword for two or more universal keywords. Further, the same word may be universal keyword and a related keyword. A website builder may build a website having text. A category most closely related to the website may be determined, such as by allowing the website builder to self-identify a category, by examining the template choices selected by the website builder, or by analyzing the text and/or images used by the website. The text may be analyzed to find one or more universal keywords associated with the category. All of the related keywords that are associated with the found universal keywords may be determined, but those related keywords already incorporated into the website are preferably excluded. One or more of the related keywords, that have not been excluded, may be displayed on an electronic device to the website builder. The website builder may provide feedback for the related keywords. Each related keyword that receives a positive response from the website builder may then be incorporated into the website to thereby increase the SEO of the website.

In another embodiment of the invention, universal keywords, related keywords, and scores are stored in an electronic database. As in the previous embodiments, each universal keyword is preferably associated with one or more related keywords. However, in this embodiment, each related keyword is associated with a score. A website builder may build a website having text as in the other embodiments. The text may be analyzed to find one or more universal keywords. All of the related keywords that are associated with the found universal keywords may be discovered. A score may be determined from the electronic database for each of the related keywords. The scores may be used to determine which related keywords are displayed on an electronic device to the website builder (the higher the score the more advantageous it is to display the keyword). The website builder may provide feedback for one or more of the related keywords. Each related keyword that receives a negative response from the website builder may have its score reduced. This will have the effect of making the related keyword less likely to be suggested in the future to other website builders. Each related keyword that receives a positive response from the website builder may have its score increased (thereby making it more likely to be suggested to website builders in the future) and be incorporated into the website to thereby increase the SEO of the website.

In another embodiment of the invention, categories, universal keywords, related keywords, and scores are stored in an electronic database. In this embodiment, each category may be associated with one or more universal keywords, each universal keyword may be associated with one or more related keywords, and each related keyword may be associated with a score. A website builder may build a website having one or more sections containing text. A category, from the categories in the electronic database, most closely related to the website may be determined. The text may be analyzed to find one or more universal keywords in the text associated with the category. All of the related keywords that are associated with the found universal keywords may be discovered. A score from the electronic database may be found for each of the related keywords. The scores may be used to determine which related keywords are to be displayed on an electronic device to the website builder. The website builder may provide a response for one or more of the displayed related keywords. Each related keyword that receives a negative response from the website builder may have its score reduced in the electronic database. Each related keyword that receives a positive response from the website builder may have its score increased in the electronic database and be incorporated into the website to thereby increase the SEO of the website.

The above features and advantages of the present inventions will be better understood from the following detailed description taken in conjunction with the accompanying drawings.

### BRIEF DESCRIPTION OF THE DRAWINGS

FIGS. 1-2 are block diagrams showing the functional components of a system for improving SEO of a website according to the present invention.

FIGS. 3-6 are tables showing data (a reduced set to assist in explaining the invention) that may be stored in an electronic database for a system for improving SEO of a website according to the present invention.

FIGS. 7-13 are flow diagrams for several different method embodiments for improving SEO of a website according to the present invention.

### DETAILED DESCRIPTION

The present inventions will now be discussed in detail with regard to the attached drawing figures which were briefly described above. In the following description, numerous specific details are set forth illustrating the Applicant's best mode for practicing the inventions and enabling one of ordinary skill in the art to make and use the inventions. It will be obvious, however, to one skilled in the art that the present inventions may be practiced without many of these specific details. In other instances, well-known machines, structures, and method steps have not been described in particular detail in order to avoid unnecessarily obscuring the present inventions. Unless otherwise indicated, like parts and method steps are referred to with like reference numerals.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Prevalent on the Web are multimedia websites, some of which may offer and sell goods and services to individuals and organizations. Websites may consist of a single webpage, but typically consist of multiple interconnected and related webpages. Menus and links may be used to move between different webpages within the website or to move to a different website as is known in the art. Websites may be created using a programming language, such as the HyperText Markup Language (HTML) to generate a standard set of tags that define how the webpages for the website are to be displayed.

Websites, unless extremely large and complex or have unusual traffic demands, typically reside on a single server and are prepared and maintained by a single individual or entity. Some Internet users, typically those that are larger and more sophisticated, may provide their own hardware, software, and connections to the Internet. But many Internet users either do not have the resources available or do not want to create and maintain the infrastructure necessary to host their own websites. To assist such individuals (or entities), hosting companies exist that offer website hosting services. These hosting service providers typically provide the hardware, software, and electronic communication means necessary to connect multiple websites to the Internet. A single hosting service provider may literally host thousands of websites on one or more hosting servers.

Users of the Internet may access content providers' websites using software known as an Internet browser, such as MICROSOFT INTERNET EXPLORER or MOZILLA FIREFOX on the users' electronic devices. After the browser has located the desired webpage, it requests and receives information from the webpage, typically in the form of an HTML document, and then displays the webpage content for the user. The user then may view other webpages at the same website or move to an entirely different website using the browser.

Browsers are able to locate specific websites because each website, resource, and computer on the Internet has a unique Internet Protocol (IP) address (e.g., 64.202.167.32, an IPv4 address, or 2EDC:BA98:0332:0000:CF8A:000C:2154:7313, an IPv6 address). IP addresses, however, even in such human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Internet users may locate websites via search engines that search for information on the World Wide Web. Commercially-available search engines include GOOGLE, YAHOO, and MICROSOFT BING. A search engine functions as an information retrieval system that, responsive to a user's search request (e.g., keyword query entered into a data field on a search engine's website), locates and returns links to websites determined by the search engine to be relevant to the submitted keywords. Search engines use various algorithms to determine which websites are most relevant to the submitted keywords.

Although the algorithm used by a specific search engine may be proprietary, it is generally known that many algorithms consider as relevant factors the frequency and location of terms on a website and the way that the website links to other websites on the Web. Websites having terms deemed relevant to the submitted keywords may be given a higher ranking. Similarly, websites that are linked to other websites deemed relevant to the submitted keywords (e.g., the other websites contain hyperlinks to the subject website) also may be given a “boost” in relevancy ranking by the search engine. Search engines generally return results, perhaps in list form on a results webpage, such as a list of vertically-arranged links, placing those links deemed (by the search engine's algorithm) to be most relevant to the submitted keywords in the most prominent location on the search result webpage (e.g., the top of the list).

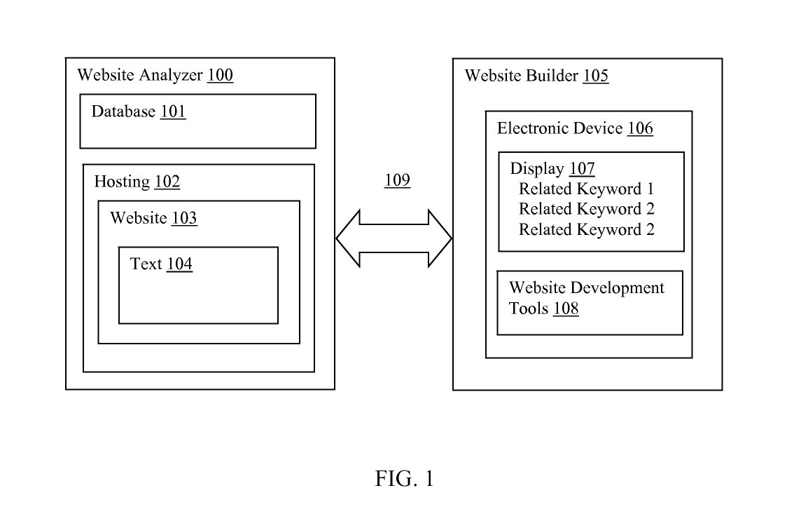

FIG. 1 is a block diagram showing the functional components of one possible system for improving the SEO of a website 103 according to the present invention. Search Engine Optimization (SEO) is the process of analyzing search engines and their algorithms to identify the factors used by the search engine to determine website 103 relevancy, and using those factors to improve a website's 103 ranking, and therefore obtain a more prominent placement on the search engine results webpage. Optimizing a website 103 for improved SEO ranking may include editing its content, HTML, metadata, and/or associated code to increase its relevance to specific keywords. It also may comprise promoting the website to other website operators to increase the number of inbound links to the website.

A website analyzer 100 may be a business that, among other things, provides services for improving the SEO of a website 103. While only one website 103 is shown in FIG. 1, the website analyzer 100 may be able to improve the SEO of any number of websites.

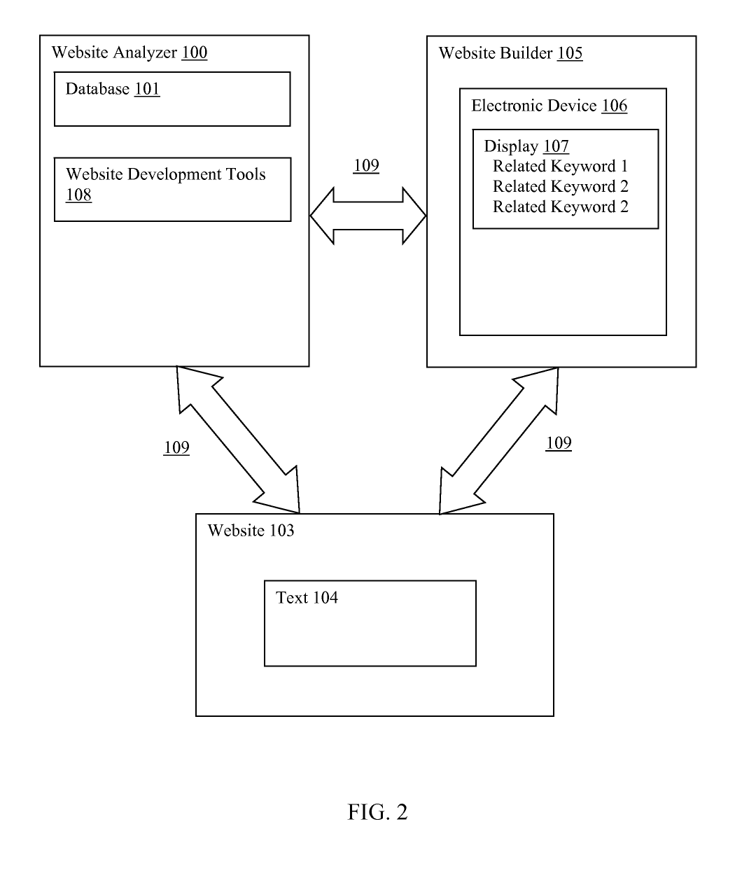

The website analyzer 100 may also provide other services for the website 103, such as providing hosting 102 services for the website 103 (shown in FIG. 1) and/or providing website design tools 108 used to design the website 103 (shown in FIG. 2). It is advantageous for the website analyzer 100 to provide design tools 108 and/or hosting 103 services as these services allow the website analyzer 100 access to modify the website's 108 code to improve the SEO of the website 103. However, FIG. 2 shows an embodiment where the website analyzer 100 does not provide hosting services for website 103, but is still able to communicate with website 103 over a computer network 109, such as the Internet.

Although the website 103 is shown in FIGS. 1-2 in a simplified manner as having a single text 104 section, the website 103 may include any number of webpages, with one or more webpages including various multimedia and text 104 sections.

The website analyzer 100 may also include an electronic database 101. The electronic database 101 may be a collection of data arranged for ease and speed of search and retrieval and be manipulated by a data-processing system. The electronic database 101 may be stored on any storage medium or combination of storage mediums, but is preferably stored on computer hard disks for reliable long term storage and/or in RAM when needed for fast data manipulation.

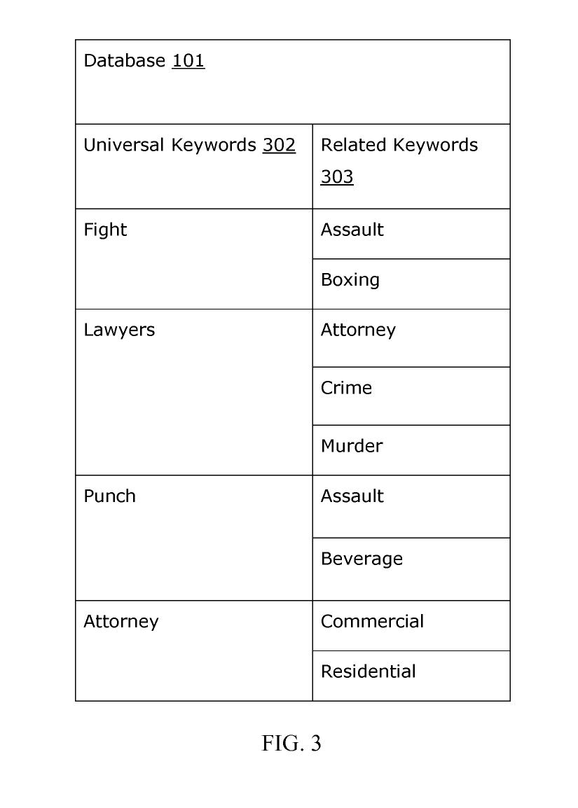

FIGS. 3-6 illustrate four possible combinations of data that may be stored in the electronic database 101. It should be noted that FIGS. 3-6 are extremely simplified for illustration purposes and in practice the database 101 would include considerably more data. In FIG. 3, a database 101 is illustrated that has a plurality of universal keywords 302 (“Fight,” “Lawyers,” “Punch,” and “Attorney”). Universal keywords 302 are words or phrases, usually nouns and verbs, which may be searched for in a website 103 as part of the process to improve the website's 103 SEO. Universal keywords 302 are preferably selected as words or phrases found in websites that are the most helpful in identifying the nature or content of the website 103. The universal keywords 302 may be ranked or prioritized based on how people search for things using search engines. Thus, a word or phrase should not be selected as a universal keyword 302 if it is too common (a noun or verb that is in virtually all websites would not be very useful) and/or would not help differentiate the nature of the website 103 from other websites.

In FIG. 3, the database 101 also has a plurality of related keywords 303 (“Assault,” “Boxing,” “Attorney,” “Crime,” “Murder,” “Assault,” “Beverage,” “Commercial,” and “Residential”). Related keywords 303 are preferably selected on the bases that if the related keyword 103 were incorporated into the website, the related keyword 103 would help a search engine correctly categorize the website 103 and/or possibly rank the website 103 higher than if the website 103 did not have the related keyword 303 incorporated. The related keywords 303 may be synonyms of their associated universal keywords 302 and/or words that are likely to be related to a website 103 that contained the associated universal keyword 302.

One or more related keywords 303 may be incorporated into a website 103 to improve the website's 103 SEO. A related keyword 303 may be incorporated into the website 103 by adding the related keywords 303 into the code of the website 103. It is preferable to add the related keyword 303 in one or more places in the website 103 known to be checked by search engines. Most code used to create websites, such as HTML, have specific places in the code for this purpose. As one specific non-limiting example of incorporating the related keyword 303 into the website 103, the related keyword may be inserted into a website 103 written in HTML using meta tags and/or other locations in the code.

Each universal keyword 302 may be associated with one or more related keywords 303. As examples, FIG. 3 shows the universal keyword 302 “Fight” associated with related keywords 303 “Assault” and “Boxing;” universal keyword 302 “Lawyers” is associated with the related keywords 303 “Attorney,” “Crime,” and “Murder,” universal keyword 302 “Punch” is associated with related keywords 303 “Assault” and “Beverage;” and the universal keyword 302 “Attorney” is associated with related keywords 303 “Commercial” and “Residential.”

When a universal keyword 302 is found in the website 103, one or more of the related keywords 303 associated with the universal keyword 302 may be displayed to a website builder 105 (related keywords 303 that are already incorporated into the website 103 are preferably not shown to the website builder 105) to determine whether or not the related keyword 303 should be incorporated into the website 103.

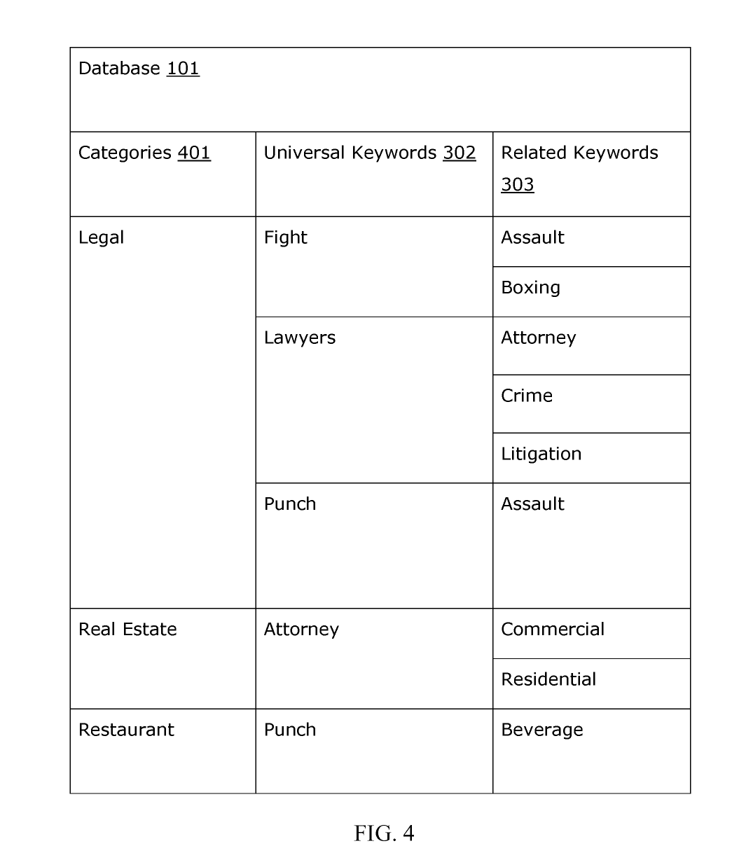

FIG. 4 includes an electronic database 101 with a plurality of categories 401. Specifically, FIG. 4 shows the categories 401 of “Legal,” “Real Estate,” and “Restaurant.” The category 401 “Legal” is associated with the universal keywords 302 “Fight,” “Lawyers,” and “Punch;” the category 401 “Real Estate” is associated with the universal keyword 302 “Attorney;” and the category 401 “Punch” is associated with the universal keyword 302 “Beverage.” Each of the universal keywords 302 in FIG. 4 may be associated with one or more related keywords 303 in a manner similar to that discussed with reference to FIG. 3.

A website 103 may be classified as fitting into one or more categories 401 in the database 101. There may be any number of categories 401, but in preferred embodiments there are 1,000s or more categories 401. The website 103 may be classified as belonging to one or more categories 401 by various methods. As examples, one or more categories 401 for a website 103 may be selected by the website builder 105, deduced from links, images or text 104 within the website 103 or from a template used to build the website 103 to name but a few of the possible methods to determine a website's 103 category 401.

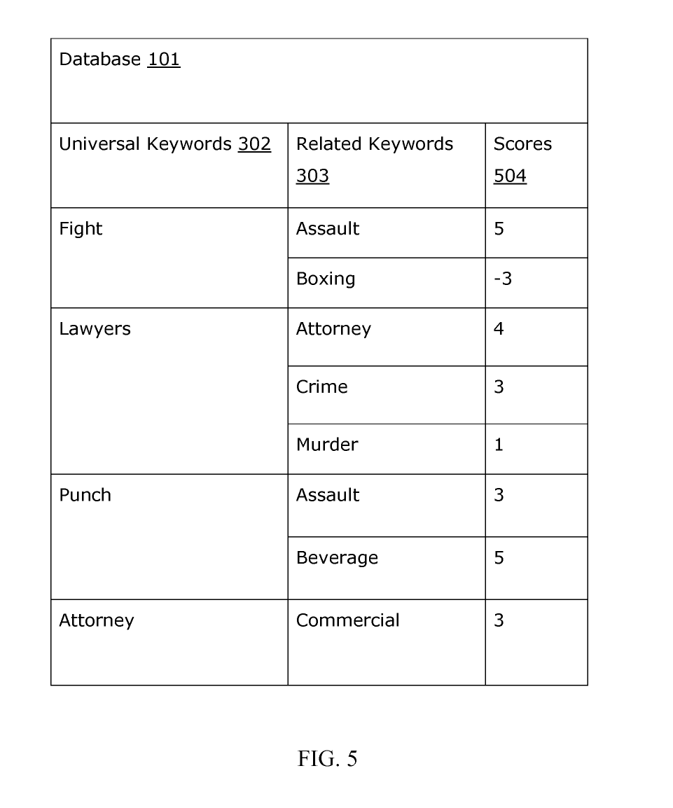

FIG. 5 includes an electronic database 101 with a plurality of scores 504. The universal keywords 302 may be associated with related keywords 303 in a manner similar to that described for FIGS. 3 and 4. In FIG. 5, the related keyword “Assault” is associated with the score 504 “5”, the related keyword 303 “Boxing” is associated with the score 504 “−3” and so on down the list until lastly the related keyword 303 “Commercial” is associated with the score 504 “3.”

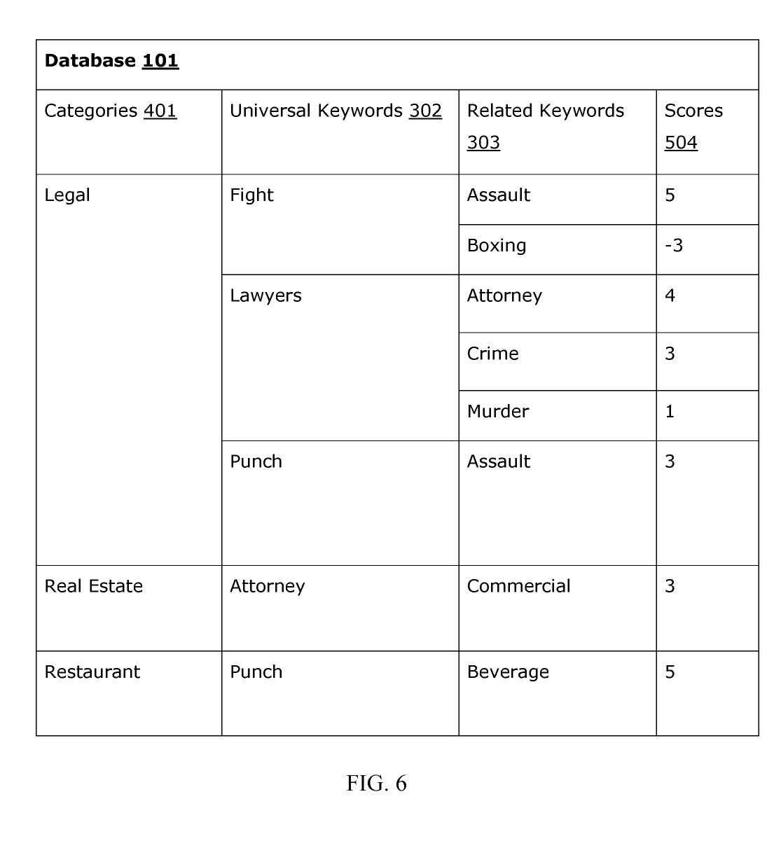

The scores 504 illustrated in FIGS. 5 and 6 are integers and this is the preferred method of storing and manipulating the scores 504. However, the scores 504 may take on any desired scale, analog or digital, numeric or text, that assists in determining whether or not an associated related keyword 303 should be displayed to a website builder 105. Related keywords 303 with higher or better scores 504 should be shown before related keywords 303 with lower or worse scores 504 (which might not be shown at all).

FIG. 6 illustrates an electronic database 101 with a plurality of categories 401, a plurality of universal keywords 302, a plurality of related keywords 303 and a plurality of scores 504. It further illustrates that each category 401 may be associated with one or more universal keywords 302, each universal keyword 302 may be associated with one or more related keywords 303, and each related keyword 303 may be associated with a score 504.

Referring back to FIG. 1, the website analyzer 100 may be in communication over a computer network 109, such as the Internet, with a website builder 105. The website builder 105 may be the person who designed, is designing, or will be designing a website 103, such as a webmaster, website designer, website operator, or website owner or a designee of one of those persons.

The website builder 105 preferably has an electronic device 106. The electronic device 106 may be, as non-limiting examples, a desk top computer, laptop computer, notebook, tablet, smart phone, cell phone or personal digital assistant (PDA). The electronic device 106 preferably has a display 107 that may display one or more related keywords 303 and the electronic device 106 may allow the website builder 105 to respond to each displayed related keyword 303. As non-limiting examples, the response may require the website builder 105 to verbally provide a positive or negative response, press an icon or area on the display 107, press a key on the electronic device 106, click on or select a related keyword 303, use a menu or type one or more characters to signify a response for one or more displayed related keyword 303.

The response from the website builder 105 is preferably a positive response if the displayed related keyword 303 matches the function and/or nature of the website 103 and a negative response if the displayed related keyword 303 does not match the function and/or nature of the website 103. A positive response will generally result in the related keyword 303 being incorporated into the website 103 while a negative response will prevent the related keyword 303 from being incorporated into the website 103.

The electronic device 105 may include website development tools 108 as shown in FIG. 1, the website development tools 108 may be included in the website analyzer 100 as shown in FIG. 2, or a combination with some website development tools 108 being located in both places. Regardless of the location of the website development tools 108, the website builder 105 may be allowed to build or design a website 103.

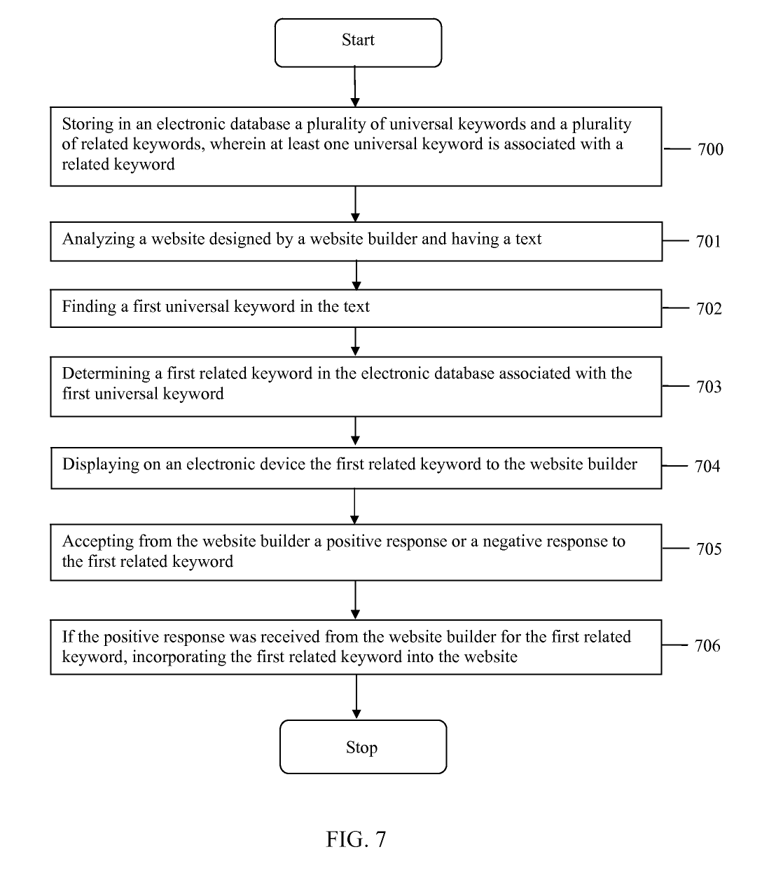

FIGS. 3 and 7 will now be referenced to describe an embodiment of the invention. Universal keywords 302 and related keywords 303 may be stored in an electronic database 101, with one or more related keywords 303 being associated with each universal keyword 302. (Step 700)

A website builder 105 may build or design a website 103 having text 104. The text 104 may be analyzed (Step 701) to find one or more universal keywords 302 (Step 702). For example, if the text 104 of the website 103 includes “World's Best Lawyers—we will fight for you!” then the universal keywords 302 “Fight” and “Lawyers” in the database 101 in FIG. 3 may be found in the text 104.

All of the related keywords associated with the found universal keywords may be determined. (Step 703) Thus, in FIG. 3, the universal keyword 302 “Fight” is associated with the related keywords 303 “Assault” and “Boxing” and the universal keyword 302 “Lawyers” is associated with the related keywords 303 “Attorney,” “Crime,” and “Murder.”

One or more of the related keywords 303 (that have not been excluded due to already being incorporated into the website 103) may be displayed on an electronic device's 106 display 107 to the website builder 105. (Step 704) So for the current example, one or more of the related keywords 303 “Assault,” “Boxing,” “Attorney,” “Crime,” and “Murder” may be chosen to be displayed on the electronic device 106.

The website analyzer 100 may accept a response, as non-limiting examples, a positive response, negative response or no response, for none, some, each, or all of the related keywords 303 from the website builder 105. (Step 705) A positive response may be used to indicate that the website builder 105 believes a displayed related keyword 303 is related to the type of website 103 being built by the website builder 105. Thus, the website builder 105 could give a positive response to “Assault,” “Attorney,” “Crime,” and “Murder,” but give a negative response (or no response) to “Boxing” if the website builder 105 was designing a website 103 for a law firm.

Each related keyword 303 that received a positive response from the website builder 105 may be incorporated into the website 103 to thereby increase the SEO of the website 103. (Step 706) In our current example, that would mean that related keywords 303 “Assault,” “Attorney,” “Crime,” and “Murder” would be incorporated into the website 103.

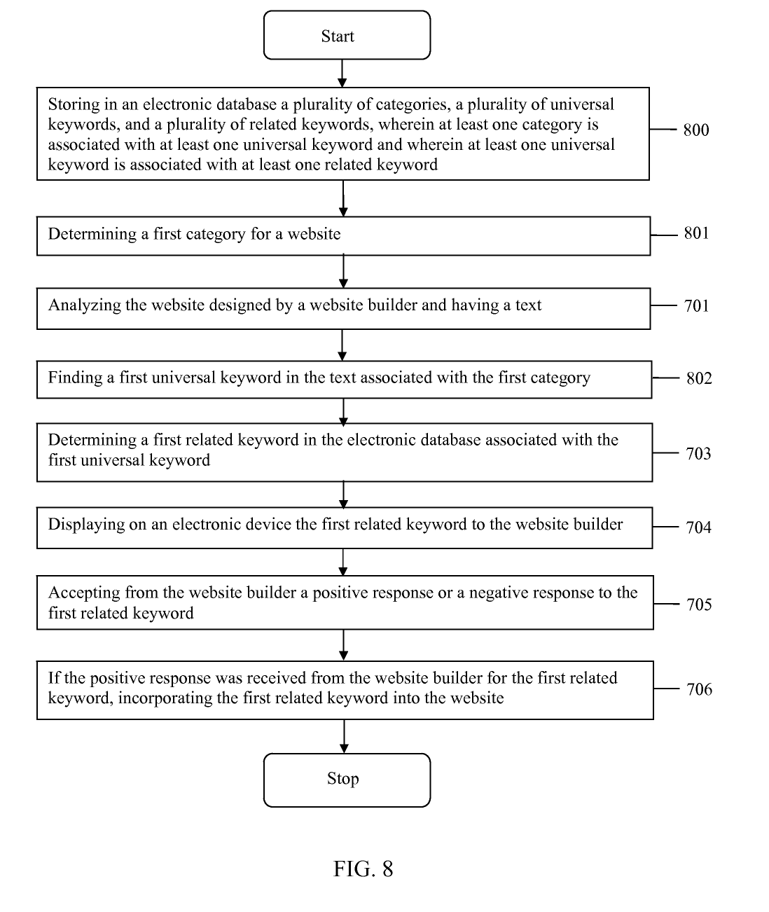

FIGS. 4 and 8 will now be used to illustrate another embodiment of the invention. In this embodiment, categories 401, universal keywords 302, and related keywords 303 are stored in the electronic database 101. Each category 401 may describe a type or nature of a website 103 and is preferably unique within the plurality of categories 401. Each category 401 is preferably associated with one or more universal keywords 302 and each universal keyword 302 is associated with one or more related keywords 303. (Step 800) Thus in FIG. 4, the category 401 “Legal” is associated with the universal keywords 302 “Fight,” “Lawyers,” and “Punch;” the category “Real Estate” is associated with the universal keyword 302 “Attorney;” and the category 401 “Restaurant” is associated with the universal keyword 302 “Punch.” In FIG. 4, the universal keywords 302 may be associated with one or more related keywords 303 in a manner similar to that described for FIG. 3.

It should be noted in the embodiments that include categories 401 that the same word or phrase may be used as a universal keyword 302 for two or more categories 401 and the same universal keyword 302 may have different related keywords 303. For example as illustrated in FIG. 6, the universal keyword 302 “Punch” is associated with the categories 401 “Legal” and “Restaurant.” The universal keyword 302 “Punch” is associated with the related keyword 303 “Assault” when associated with the “Legal” category 401, but the universal keyword 302 “Punch” is associated with the related keyword 303 “Beverage” when associated with the category 401 “Restaurant.” Thus, categories 401 may be very beneficial in determining which related keywords 303 should be associated with which universal keywords 302.

One or more categories 401 most closely related to the website 103 may be determined by any desired method, such as by allowing the website builder 105 to self-identify one or more categories 401, by examining the website template choices selected by the website builder 105, or by analyzing the text 104, links, code, and/or images used by the website 103. (Step 801) For purposes of this example, let's assume it is determined that the website 103 belongs to the “Legal” category 401.

The text 104 of the website 103 may be analyzed to find one or more universal keywords 302 associated with the category 401. (Steps 701 and 802) Thus, if the website 103 has been determined to be in the “Legal” category 401 as shown in FIG. 4, the website's 103 text 104 may be searched for the universal keywords 302 “Fight,” “Lawyers,” and “Punch.”

The remaining steps in this embodiment are very similar to the corresponding steps in the previous embodiment. Specifically, the related keywords 303 (“Assault,” “Boxing,” “Attorney,” “Crime,” and “Murder”) that are associated with the found universal keywords 304 (“Fight,” “Lawyers,” and “Punch”) may be determined. (Step 703) One or more of the related keywords 303 may be displayed on an electronic device 106 to the website builder 105. (Step 704) The website builder 105 may provide a response for one or more of the related keywords 303. (Step 705) Each related keyword 303 that receives a positive response from the website builder 105 may then be incorporated into the website 103 to thereby increase the SEO of the website 103. (Step 706)

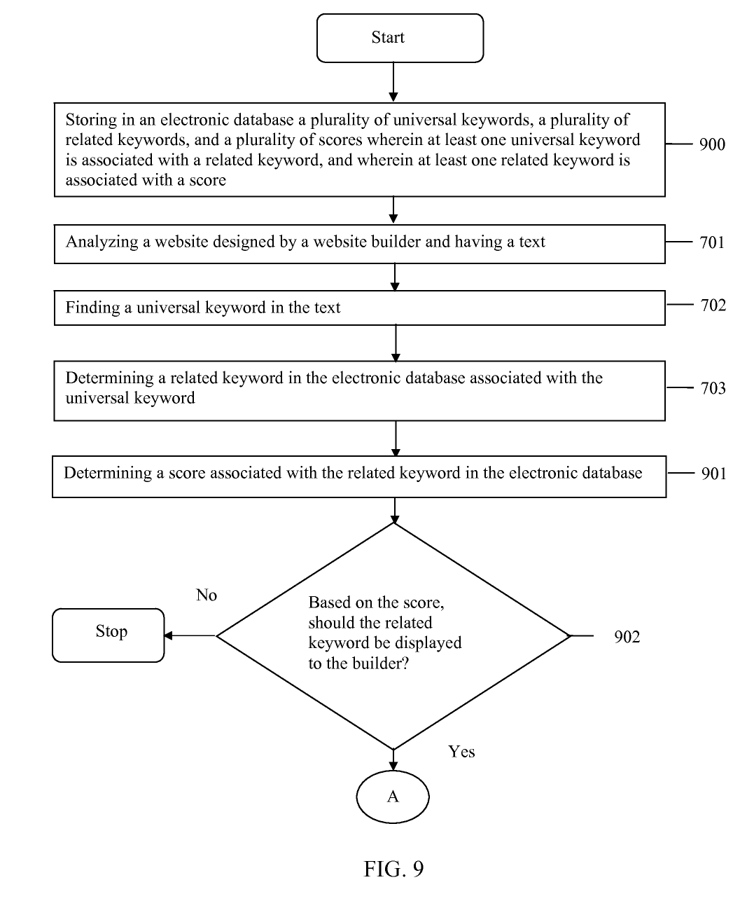

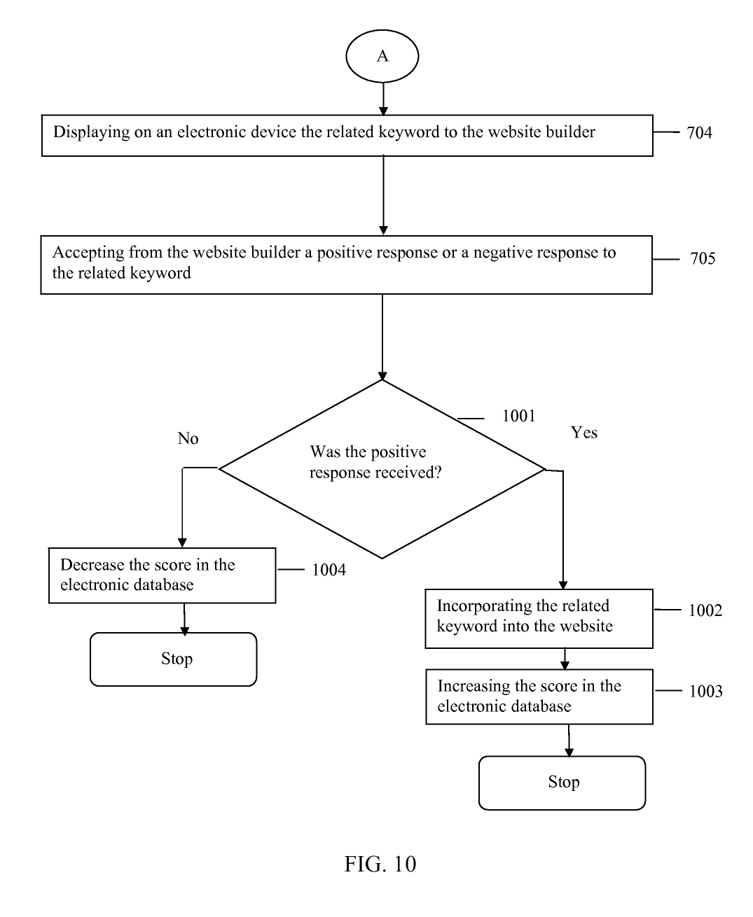

FIGS. 5, 9 and 10 will now be used to illustrate another embodiment of the invention. In this embodiment, universal keywords 302, related keywords 303, and scores 504 are stored in an electronic database 101. As in previous embodiments, each universal keyword 302 is preferably associated with one or more related keywords 303. However, in this embodiment, related keywords 303 are also associated with a score 504. (Step 900) The same related keyword 303 (the word is the same, but may be stored in a different location in the database 101) may be associated with a different score 504 if the related keyword 303 is associated with a different universal keyword 302. As examples, related keyword 303 “Assault” is associated with a score 504 of “5” when associated with the universal keyword 302 “Fight,” but “Assault” (the same word, but possibly stored in a different location in the database 101) is associated with a score 504 of “3” when associated with the different universal keyword 302 of “Punch.”

Another method of storing data in the database 101 is using a relational database. With a relational database, universal keywords 302, related keywords 303, and/or scores 504 that are functionally used in a plurality of places in the data structures illustrated in FIGS. 3-6, may be stored once in the database 101 with many to many relationships used to create the desired data structure.

As previously discussed, the text 104 of the website 103 may be analyzed to find one or more universal keywords 302. (Steps 701 and 702) The found universal keywords 302 may be used to determine their associated related keywords 303 from the database 101. (Step 703)

In this embodiment, a score 504 may be determined from the electronic database 101 for each of the found related keywords 303. (Step 901) The scores 504 may be used to determine which related keywords 303 are to be displayed on an electronic device 106 to the website builder 105 (the higher the score 504 the more advantageous it is to display the related keyword 303). (Step 902)

As a specific example illustrated in FIG. 5, if universal keyword 302 “Fight” is found in the website 103, then the related keyword 303 “Assault” is determined to have a score 504 of “5” and the related keyword 303 “Boxing” is determined to have a score 504 of “−3.” Based on these scores, it may be programmatically determined to display the related keyword 303 “Assault” with a score 504 of “5,” but not to display the related keyword 303 “Boxing” due to its low score 504 of “−3.”

As a general rule, related keywords 303 with a higher score 504 should be displayed before related keywords 303 with a lower score 504. Any method may be used to determine which related keyword(s) 303 is/are to be displayed, with non-limiting examples being all the related keywords 303 with a positive score 504, the top three (or any other selected number) related keywords 303 with the highest scores 504, or the top 50% (or any other percentage) of related keywords 303 with the highest scores 504.

A challenge for the above described method is that the related keywords 303 with lower scores 504 will eventually stop being displayed and thus will be prevented from ever improving their scores 504. To remedy this situation, it may be desirable to periodically or randomly include one or more related keywords 303 with lower scores 504 to allow the related keywords 303 with lower scores 504 to also continue to be evaluated and ranked by website builders 105. Another idea to combat the scores 504 for related keywords 303 becoming too polarized is to have a max and/or a min score 504. This may help related keywords 303 with lower scores 504 to still be displayed occasionally to website builders 105.

The type of electronic device 106 held by the website builder 105 may also be used to determine the number of related keywords 303 to display. If the electronic device 106 is determined to have a large display 107 (such as a desktop computer), more related keywords 303 may be displayed than if the electronic device 106 is determined to have a small display 107 (such as a mobile device).

Once the related keywords 303 are selected to be displayed based on the related keyword's 303 scores 504 (and possibly the size of the electronic device's display 107), one or more related keywords 303 are displayed on the website builder's 105 electronic device 106. (Step 704)

The website analyzer 100 may accept and analyze one or more responses from the website builder 105 for the one or more displayed related keywords 303. (Steps 705 and 1001)

Each displayed related keyword 303 that receives a negative response from the website builder 105 may have its score reduced. (Step 1004) This will have the effect of making this related keyword 303 less likely to be suggested in the future to other website builders for other websites.

Each displayed related keyword 303 that receives a positive response from the website builder 105 may have its score increased. (Step 1003) This will have the effect of making this related keyword 303 more likely to be suggested in the future to other website builders for other websites. The positive response also indicates that the displayed related keyword 303 should be incorporated into the website 103 to thereby increase the SEO of the website 103. (Step 1002)

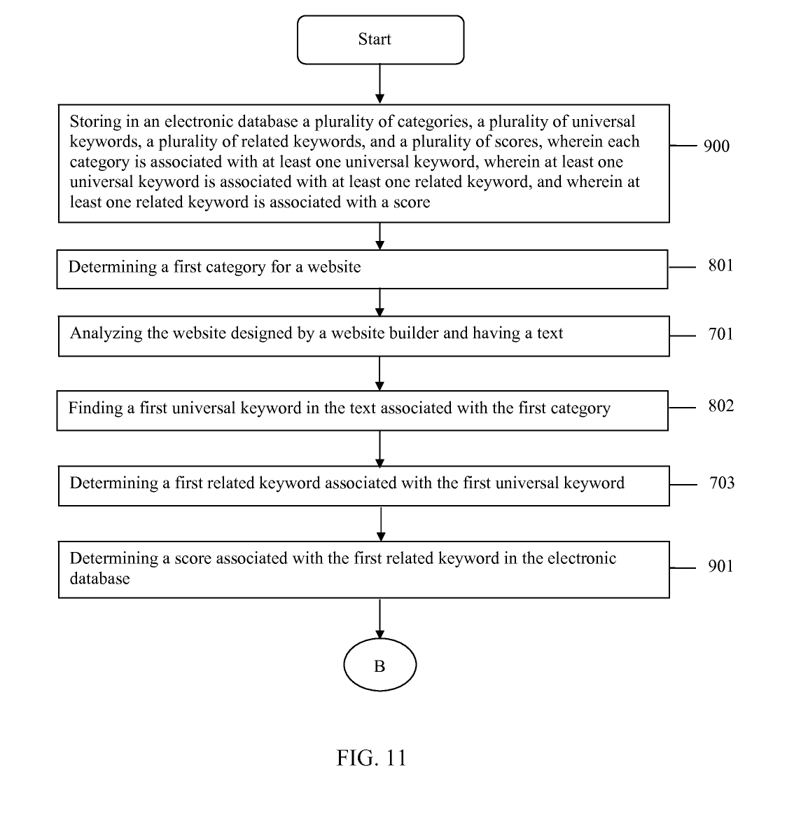

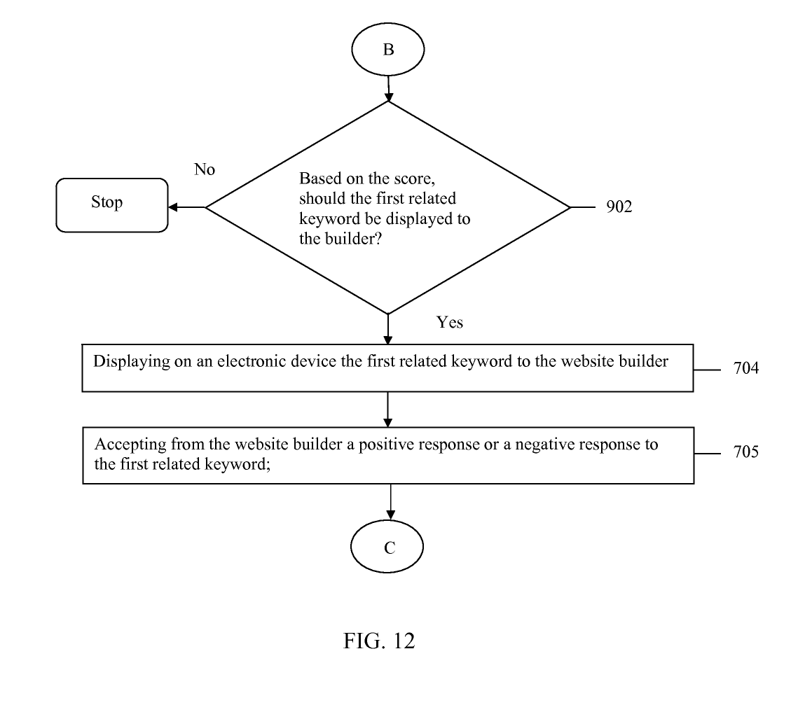

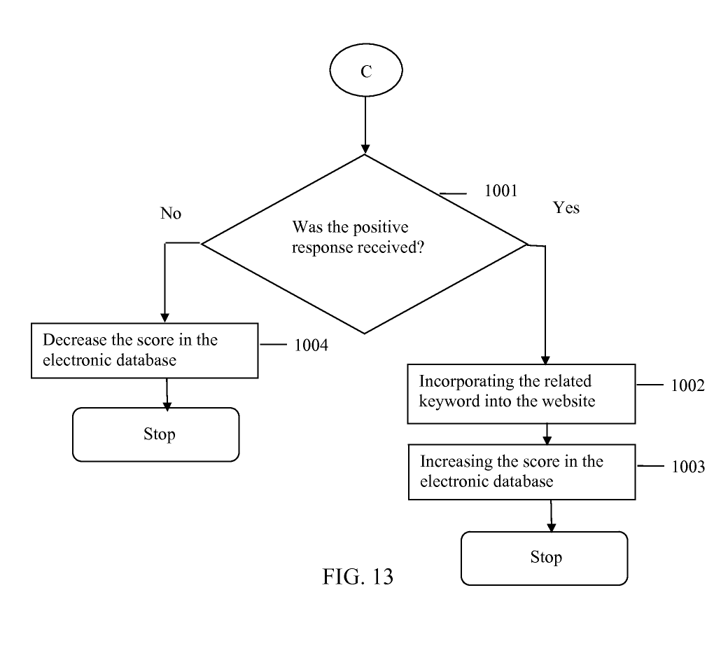

FIGS. 6, 11, 12 and 13 will now be used to illustrate another embodiment of the invention. This embodiment is basically a combination of the elements in the previous embodiments. In this embodiment, categories 401, universal keywords 302, related keywords 303, and scores 504 are stored in the electronic database 101. Each category 401 may be associated with one or more universal keywords 302; each universal keyword 302 may be associated with one or more related keyword 303; and each related keyword 303 may be associated with a score 504. (Step 1200)

A website builder 105 may design a website 103 having one or more sections containing text 104. One or more categories 401, from the categories 401 in the electronic database 101, most closely related to the website 103 may be determined as previously described. (Step 801)

The text 104 in the website 103 may be analyzed to find one or more universal keywords 302 associated with the one or more categories 401 in the text 104. (Steps 701 and 802)

All of the related keywords 303 that are associated with the universal keyword(s) 302 found in the website 103 may be determined. (Step 703)

A score 504 from the electronic database 101 may be found for each of the related keywords 303. (Step 901)

The scores 504 may be used to determine which related keywords 303 are to be displayed on an electronic device 106 to the website builder 105. (Steps 704 and 902)

The website analyzer 100 may accept a response from the website builder 105 for one or more of the displayed related keywords 303. (Step 705)

Each displayed related keyword 303 that receives a negative response from the website builder 105 may have its score reduced. (Step 1004)

Each displayed related keyword 303 that receives a positive response from the website builder 105 may have its score increased. (Step 1003) The positive response also indicates that the displayed related keyword 303 should be incorporated into the website 103 to thereby increase the SEO of the website 103. (Step 1002)

For purposes of this specification and claims, the term “associated” should be understood to work in both directions. Specifically, when a category 401 is associated with a universal keyword 302, it therefore follows the universal keyword 302 is associated with the category 401; when a universal keyword 302 is associated with a related keyword 303, it therefore follows the related keyword 303 is associated with the universal keyword 302; and when a related keyword 303 is associated with a score 504, it therefore follows the score 504 is associated with the related keyword 303.

The language used in the specification has been principally selected for readability and instructional purposes, and it may not have been selected to delineate or circumscribe the inventive subject matter. It is therefore intended that the scope of the inventions be limited not by this detailed description, but rather by any claims that issue on an application based hereon. Accordingly, the disclosure of the embodiments of the invention is intended to be illustrative, but not limiting, of the scope of the invention, which is set forth in the accompanying claims.

Thus, other embodiments and uses of the above inventions will be apparent to those having ordinary skill in the art upon consideration of the specification and practice of the inventions disclosed herein. The specification and examples given should be considered exemplary only, and it is contemplated that the appended claims will cover any other such embodiments or modifications as fall within the true scope of the inventions.

The Abstract accompanying this specification is provided to enable the United States Patent and Trademark Office and the public generally to determine quickly from a cursory inspection the nature and gist of the technical disclosure and in no way intended for defining, determining, or limiting the present inventions or any of its embodiments.

The inventions claimed are:

1. A method, comprising:
A) storing in an electronic database a plurality of universal keywords and a plurality of related keywords, wherein at least one universal keyword is associated with a related keyword;
B) analyzing a website, designed by a website builder, having a text;
C) finding a first universal keyword in the text;
D) determining a first related keyword in the electronic database associated with the first universal keyword;
E) displaying on an electronic device the first related keyword to the website builder;
F) accepting from the website builder a response to the first related keyword; and
G) if the response is a positive response from the website builder for the first related keyword, incorporating the first related keyword into the website.

2. The method of claim 1, further comprising the step of hosting the website.

3. The method of claim 1, further comprising the step of providing a website development tool to allow the website builder to build the website.

4. The method of claim 1, wherein the determined first related keyword in step D) is not incorporated into the website prior to step G).

5. The method of claim 1, further comprising the steps of:
H) finding a second universal keyword in the text;
I) determining two or more related keywords in the electronic database that are associated with the second universal keyword;
J) displaying on the electronic device the two or more related keywords to the website builder;
K) accepting from the website builder a response for each of the two or more related keywords; and
L) incorporating each related keyword in the two or more related keywords into the website for each related keyword that received a positive response from the website builder.

6. The method of claim 1, wherein at least one universal keyword in the plurality of universal keywords is associated with a category.

7. The method of claim 1, wherein at least one related keyword in the plurality of related keywords is associated with a score.

8. The method of claim 1, wherein at least one universal keyword in the plurality of universal keywords is associated with a category, wherein the category is associated with a second related keyword in the plurality of keywords, and wherein the second related keyword is associated with a score.

9. A method, comprising:
A) storing in an electronic database a plurality of categories, a plurality of universal keywords, and a plurality of related keywords, wherein at least one category is associated with at least one universal keyword and wherein at least one universal keyword is associated with at least one related keyword;
B) determining a first category for a website;
C) analyzing the website, built by a website builder, having a text;
D) finding a first universal keyword in the text associated with the first category;
E) determining a first related keyword associated with the first universal keyword;
F) displaying on an electronic device the first related keyword to the website builder;
G) accepting from the website builder a response to the first related keyword; and
H) if the response is a positive response, incorporating the first related keyword into the website.

10. The method of claim 9, further comprising the step of hosting the website.

11. The method of claim 9, further comprising the step of providing a website development tool to allow the website builder to build the website.

12. The method of claim 9, wherein at least one category in the plurality of categories is associated with two or more universal keywords and wherein at least one universal keyword is associated with at least one related keyword in the plurality of related keywords.

13. The method of claim 9, wherein the determined first related keyword in step E) is not incorporated into the website prior to step H).

14. The method of claim 9, further comprising the steps of:
H) finding a second universal keyword in the text associated with the first category;
I) determining two or more related keywords in the electronic database that are associated with the second universal keyword;
J) displaying on the electronic device the two or more related keywords to the website builder;
K) accepting from the website builder a response for each of the two or more related keywords; and
L) incorporating each related keyword in the two or more related keywords into the website for each related keyword that received a positive response from the website builder.

15. The method of claim 9, wherein at least one related keyword in the plurality of related keywords is associated with a score.

16. A method, comprising:
A) storing in an electronic database a plurality of universal keywords, a plurality of related keywords, and a plurality of scores wherein at least one universal keyword is associated with a related keyword, and wherein at least one related keyword is associated with a score;
B) analyzing a website, built by a website builder, having a text;
C) finding a universal keyword in the text;
D) determining a related keyword associated with the universal keyword in the electronic database;
E) determining a score associated with the related keyword in the electronic database;
F) using the score to determine if the related keyword should be displayed to the website builder;
G) if the related keyword should be displayed to the website builder based on the score:
i) displaying on an electronic device the related keyword to the website builder;
ii) accepting from the website builder a response to the related keyword;
iii) if the response is a negative response, reducing the score in the electronic database associated with the related keyword; and
iv) if the response is a positive response:
a) incorporating the related keyword into the website; and
b) increasing the score in the electronic database associated with the related keyword.

17. The method of claim 16, further comprising the step of:
H) hosting the website.

18. The method of claim 16, further comprising the step of:
H) providing a website development tool to allow the website builder to build the website.

19. The method of claim 16, wherein at least one universal keyword in the plurality of universal keywords is associated with at least two related keywords in the plurality of related keywords.

20. The method of claim 16, further comprising the steps of:
H) finding a second universal keyword in the text;
I) determining a second related keyword and a third related keyword in the electronic database that are associated with the second universal keyword;
J) determining a second score associated with the second related keyword and a third score associated with the third related keyword in the electronic database;
K) using the second score to determine if the second related keyword should be displayed to the website builder;
L) if the second related keyword should be displayed to the website builder based on the score:
i) displaying on the electronic device the second related keyword to the website builder;
ii) accepting from the website builder a second response for the second related keyword;
iii) if the second response is a positive response from the website builder:
a) incorporating the second related keyword into the website; and
b) increasing the second score;
iv) if the second response is a negative response, decreasing the second score; and
M) using the third score to determine if the third related keyword should be displayed to the website builder;
N) if the third related keyword should be displayed to the website builder based on the third score:
i) displaying on the electronic device the third related keyword to the website builder;
ii) accepting from the website builder a third response for the third related keyword;
iii) if the third response is positive from the website builder:
a) incorporating the third related keyword into the website; and
b) increasing the third score; and
iv) if the third response is negative from the web site builder, decreasing the third score.

21. A method, comprising:
A) storing in an electronic database a plurality of categories, a plurality of universal keywords, a plurality of related keywords, and a plurality of scores, wherein each category is associated with at least one universal keyword, wherein at least one universal keyword is associated with at least one related keyword, and wherein at least one related keyword is associated with a score;
B) determining a category within the plurality of categories, for a website designed by a website builder, having a text;
C) analyzing the text;
D) finding a universal keyword within the plurality of universal keywords associated with the category, in the text;
E) determining a related keyword within the plurality of related keywords associated with the universal keyword;
F) finding a score within the plurality of scores associated with the related keyword;
G) using the score to determine if the related keyword should be displayed to the website builder;
H) if the related keyword should be displayed to the website builder based on the score:
i) displaying on an electronic device the related keyword to the website builder;
ii) accepting from the website builder a response to the related keyword;
iii) if the response is a negative response from the website builder for the related keyword, reducing the score in the electronic database associated with the related keyword; and
iv) if the response is a positive response from the website builder for the related keyword:
a) incorporating the related keyword into the website; and
b) increasing the score in the electronic database associated with the related keyword.
